(19) United States
(12) Patent Application Publication
(10) Pub. No.: US 2024/0013983 A1
(43) Pub. Date: Jan. 11, 2024

(54) SOLID ELECTROLYTIC CAPACITOR, SOLID ELECTROLYTE, CONDUCTIVE POLYMER DISPERSION, OXIDATION ACCELERATOR, METHOD FOR PRODUCING SOLID ELECTROLYTIC CAPACITOR, AND METHOD FOR PRODUCING CONDUCTIVE POLYMER DISPERSION

(71) Applicant: NIPPON CHEMI-CON CORPORATION, Tokyo (JP)

(72) Inventors: Yoshiki KAWAI, Ibaraki (JP); Shingo Takeuchi, Ibaraki (JP); Kenji Machida, Ibaraki (JP)

(21) Appl. No.: 18/028,429

(22) PCT Filed: Sep. 14, 2021
(86) PCT No.: PCT/JP2021/033684

§ 371 Date: Mar. 24, 2023

(30) Foreign Application Priority Data
Sep. 29, 2020 (JP) 2020-163210

(51) Int. Cl. H01G 9/028; H01G 9/15; H01G 9/042

(52) U.S. Cl. CPC H01G 9/028; H01G 9/15; H01G 9/042

(57) ABSTRACT

The objective of the present disclosure is to improve the electrical conductivity of conductive polymers and to provide an electrolytic capacitor using conductive polymers with high electrical conductivity. The solid electrolytic capacitor uses the conductive polymer in which an index D derived by D=(B+C)/A is 4 or more based on an absorbance A at 585 nm, an absorbance B at 800 nm, and an absorbance C at 1200 nm in a light absorption spectrum of the conductive polymer.

### FIELD OF INVENTION

The present disclosure relates to a solid electrolytic capacitor, a solid electrolyte, conductive polymer dispersion, oxidation accelerator, and production methods thereof.

### BACKGROUND

Capacitors are passive elements that store and discharge electric charge according to capacitance. Electrolytic capacitors are increasingly used in digital devices in which information processing in high-frequency range of several kHz or more is becoming common. For example, electrolytic capacitors for high frequency smoothing use are increasingly employed. Therefore, the electrolytic capacitor with excellent ESR (Equivalent Series Resistance) in high frequency range is desired.

As a capacitor with excellent ESR in the high-frequency range, there is an electrolytic capacitor using electrolytic solution. The electrolytic capacitor includes valve action metal, such as tantalum or aluminum, as an anode foil and a cathode foil. A surface of the anode foil is enlarged by making the valve action metal into a sintered body or a shape such as an etching foil, and the enlarged surface has a dielectric oxide film layer. The electrolytic solution is interposed between the anode foil and the cathode foil. The electrolytic solution closely contacts with the uneven surface of the anode foil and acts as a true cathode.

In recent years, a solid electrolytic capacitor using a solid electrolyte including conductive polymers such as polypyrrole, polyaniline, and polythiophene has been employed to achieve lower ESR. In particular, polyethylene dioxythiophene (PEDOT) doped with polystyrene sulfonic acid (PSS) contributes to the lower

ESR of the solid electrolytic capacitor because it has high electrical conductivity.

### PRIOR ART DOCUMENT

### Patent Document

Patent Document 1: JP 2007-091656

### SUMMARY OF INVENTION

### Problems to be Solved by Invention

A solid electrolytic capacitor with even lower ESR is demanded by conductive polymers with electrical conductivity higher than PEDOT/PSS. The present disclosure has been proposed to solve the above problems, the objective is to improve the electrical conductivity of conductive polymers and to provide an electrolytic capacitor using conductive polymers with high electrical conductivity.

### Means to solve the Problem

To address the above objective, a solid electrolytic capacitor of the present disclosure includes: a capacitor element formed by an anode foil and a cathode foil facing each other; and a conductive polymer adhered in the capacitor element, in which an index D derived by the following formula is 4 or more based on an absorbance A at 585 nm, an absorbance B at 800 nm, and an absorbance C at 1200 nm in a light absorption spectrum of the conductive polymer.

D=(B+C)/A

Furthermore, a solid electrolyte of the present disclosure includes a conductive polymer, in which an index D derived by the following formula is 4 or more based on an absorbance A at 585 nm, an absorbance B at 800 nm, and an absorbance C at 1200 nm in a light absorption spectrum. When the solid electrolytic capacitor includes this solid electrolyte, the solid electrolytic capacitor using the conductive polymer with high electrical conductivity can be produced.

D=(B+C)/A

Furthermore, in conductive polymer dispersion of the present disclosure, an index D derived by the following formula is 4 or more based on an absorbance A at 585 nm, an absorbance B at 800 nm, and an absorbance C at 1200 nm in a light absorption spectrum of the conductive polymer. When this dispersion is used, the solid electrolytic capacitor using the conductive polymer with high electrical conductivity can be produced.

D=(B+C)/A

The conductive polymer of the solid electrolytic capacitor and the conductive polymer dispersion may be polyethylene dioxythiophene doped with polystyrene sulfonic acid.

Furthermore, the present disclosure includes oxidation accelerator for chemical oxidative polymerization reaction to produce a conductive polymer, and the oxidation accelerator includes an iron (III) salicylate complex. When this oxidation accelerator is used, the solid electrolytic capacitor using the conductive polymer with high electrical conductivity can be produced.

Furthermore, a production method of a solid electrolytic capacitor according to the present disclosure includes: a production process of producing a capacitor element in which a pair of electrode bodies face each other, and an adhesion process of adhering a conductive polymer in the capacitor element, in which the adhesion process includes a polymerization process of producing the conductive polymer by performing chemical oxidative polymerization in solution including an iron (III) salicylate complex and monomers forming a conjugated polymer.

In the adhesion process, the capacitor element may be impregnated with dispersion obtained by the polymerization process.

The polymerization process may include oxidation accelerator production process of adding borodisalicylic acid salt or salicylic acid salt and an iron (III) compound to the solution and producing the iron (III) salicylate complex in the solution.

Furthermore, the production method of conductive polymer dispersion according to the present disclosure includes performing chemical oxidative polymerization in solution including an iron (III) salicylate complex and monomers forming a conjugated polymer. When the process includes using this dispersion, the solid electrolytic capacitor using the conductive polymer with high electrical conductivity can be produced.

The present disclosure may include oxidation accelerator production process of adding borodisalicylic acid salt or salicylic acid salt and an iron (III) compound to the solution and producing the iron (III) salicylate complex in the solution.

### Effect of Invention

According to the present disclosure, the conductive polymer with high electrical conductivity can be achieved.

### EMBODIMENTS

Hereinafter, embodiments of the present disclosure will be described. Note that the present disclosure is not limited to the following embodiments.

An electrolytic capacitor is a passive element that stores and discharges electric charge according to capacitance. The solid electrolytic capacitor includes solid electrolytic capacitors using only a solid electrolyte layer, and hybrid electrolytic capacitors in which a solid electrolyte and electrolytic solution are used in combination. Furthermore, the solid electrolytic capacitors include a solid electrolytic capacitor with dielectric oxide film intentionally formed only on the anode side, and bipolar solid electrolytic capacitors with dielectric oxide film formed on both electrodes.

The solid electrolytic capacitor is formed by housing a capacitor element in a casing and sealing an opening of the casing by a sealing body. The capacitor element includes an anode foil, a cathode foil, a separator, and a solid electrolyte layer. The anode foil and the cathode foil face each other via a separator. A dielectric oxide film is formed on a surface of the anode foil. A dielectric oxide film layer is also formed on the cathode foil, if necessary. The solid electrolyte is interposed between the anode foil and the cathode foil, and is in close contact with the dielectric oxide film. The solid electrolyte layer is formed by impregnating the capacitor element with conductive polymer dispersion and drying the capacitor element.

The anode foil and the cathode foil are long foil bodies formed of valve acting metal. The valve acting metal is aluminum, tantalum, niobium, niobium oxide, titanium, hafnium, zirconium, zinc, tungsten, bismuth, and antimony, etc. The purity of the anode foil is desirably 99.9% or more, and the purity of the cathode foil is desirably about 99% or more, however impurities such as silicon, iron, copper, magnesium, and zinc may be included.

The surface of the anode foil is enlarged as a molding formed by molding powder of valve action metal, a sintered body obtained by sintering powder of valve action metal, or etching foil obtained by etching a stretched foil. The enlarged surface structure is formed by tunnel-shaped etching pits, spongy pits, or gaps between dense powder. Typically, the enlarged surface structure is formed by direct current etching or alternating current etching in which direct current or alternating current is applied in acidic aqueous solution containing halogen ions such as hydrochloric acid, or is formed by depositing or sintering metal particles, etc., on a core. The cathode foil may also have the enlarged surface structure by deposition, sintering, or etching.

Typically, the dielectric oxide film is oxide film formed on a surface layer of the anode foil. For example, when the anode foil is made of aluminum, the dielectric oxide film is aluminum oxide obtained by oxidizing the enlarged surface structure. The dielectric oxide film is formed by chemical conversion treatment in which voltage is applied in aqueous solution of adipic acid, boric acid, or phosphoric acid, etc. Furthermore, thin dielectric oxide film (about 1 to 10 V) may be formed on the surface layer of the cathode foil by chemical conversion treatment, if necessary. In addition, the dielectric oxide film may be formed by vapor deposition of a layer consisting of metal nitrides, metal carbides, or metal carbonitrides, or may be produced by using material containing carbon on a surface thereof.

The separator includes cellulose such as kraft, Manila hemp, esparto, hemp, rayon, and mixed papers thereof, polyester resin such as polyethylene terephthalate, polybutylene terephthalate, polyethylene naphthalates, and derivatives thereof, polytetrafluoroethylene resin, polyvinylidene fluoride resin, vinylon resin, polyamide resin such as aliphatic polyamide, semi-aromatic polyamide, and total aromatic polyamide, polyimide resin, polyethylene resin, polypropylene resin, trimethylpentene resin, polyphenylene sulfide resin, acrylic resin, polyvinyl alcohol resin and the like, and these resin may be used in single or in combination.

The solid electrolyte layer is formed by including the solid electrolyte, and the solid electrolyte includes conductive polymers. The conductive polymer is a conjugated polymer which incorporates polystyrene sulfonic acid (PSS) as a dopant. Incorporating as a dopant is a state in which the conjugated polymer and the dopant are positively and negatively charged, respectively, and the conjugated polymer become polaron or bipolaron, and the conductive polymer becomes conductive.

The conductive polymer has a light absorption spectrum in which an index D derived from the following formula is 4 or more. The light absorption spectrum may be obtained by an ultraviolet-visible spectroscopy (UV-vis). In the formula 1, A is an absorbance at 585 nm, B is an absorbance at 800, and C is an absorbance at 1200 nm. If the conductive polymer in the doped state expressed by the light absorption spectrum that satisfies the index D of 4 or more, the electrical conductivity of the solid electrolyte layer becomes higher and ESR of the solid electrolytic capacitor is suppressed low.

D=(B+C)/A (Formula 1)

It is preferable that aggregate of the conductive polymer is unraveled to a level in which a particle size is 0.1 μm or less. If 90% of the conductive polymer passes through a filter with 0.1 μm opening, the particle size of the conductive polymer is 0.1 μm or less. When the conductive polymer has this particle size, many conductive polymers can adhere in the pits or gaps of the dielectric oxide film, and Cap (capacitance) in the low-frequency range such as 120 Hz, ESR, and tan δ (dielectric loss tangent) of the solid electrolytic capacitor becomes excellent.

As the conjugated polymer, known polymers may be used without limitation. Examples include polypyrrole, polythiophene, polyfuran, polyaniline, polyacetylene, polyphenylene, polyphenylenevinylene, polyacene, and polythiophenevinylene, etc. These conjugated polymers may be used in single or or in combination of two or more, and may further be a copolymer of two or more monomers.

Among the above-described conjugated polymers, conjugated polymers obtained by polymerizing thiophene or derivatives thereof is preferable, and conjugated polymers in which 3,4-ethylenedioxythiophene (that is, 2,3-dihydrothieno [3,4-b] [1,4]dioxin), 3-alkylthiophene, 3-alkoxythiophene, 3-alkyl-4-alkoxythiophene, 3,4-alkylthiophene, 3,4-alkoxythiophene, or derivatives thereof are polymerized are preferred. The thiophene derivatives may preferably be a compound selected from thiophene with substituents at the 3-position and 4-position, and the 3-position and 4-position substituents of the thiophene ring may form a ring together with the 3-position and 4-position carbon. It is preferable that the carbon number of alkyl groups and alkoxy groups is 1 to 16.

The thiophene derivatives in which the carbon number of alkyl groups and alkoxy groups is 1 to 16 may include alkylated ethylenedioxythiophene in which alkyl groups are added to 3,4-ethylenedioxythiophene, and for example, may be methylated ethylenedioxythiophene (that is, 2-methyl-2,3-dihydro-thieno[3,4-b] [1,4]dioxin), ethylated ethylenedioxythiophene (that is, 2-ethyl-2,3-dihydro-thieno [3,4-b] [1,4]dioxin), etc.

In particular, the preferable conjugated polymer is a polymer of 3,4-ethylenedioxythiophene which is called EDOT, that is, poly(3,4-ethylenedioxythiophene) which is called PEDOT. PEDOT expresses excellent electrical conductivity and high heat-resistance, among conductive polymers.

The solid electrolyte layer is formed by impregnating the capacitor element with dispersion. The dispersion is conductive polymer dispersion in which the conductive polymer with the light absorption spectrum of the index D of 4 or more is dispersed. By impregnating the capacitor element with the dispersion, the conductive polymer adheres to the dielectric oxide film, and the solid electrolyte layer including the conductive polymer is formed on the capacitor element. Depressurization process or pressurization process may be performed to facilitate the impregnation to the capacitor element. The impregnation process may be repeated for multiple times.

Note that if the solid electrolyte layer is formed on the capacitor element, other method such as impregnating the capacitor element with manufactured dispersion may be employed. For example, dispersion may be adhered to one or more components selected from the anode foil, the cathode foil, and the separator to remove a portion of a solvent, and the capacitor element may be formed using said components.

The dispersion is formed by adding monomers forming the conjugated polymer, polystyrene sulfonic acid (PSS) that is the dopant, and oxidation accelerator to a solvent, and performing chemical oxidative polymerization. Although there is no strict limitation for the temperature during the chemical oxidative polymerization, the temperature is generally in the range of 0 to 60° C. The polymerization time is generally in the range of 10 minutes to 30 hours. The dispersion may be purified by performing ultrafiltration, stirring, or ultrafiltration and concentration adjustment, etc. Furthermore, additives may be added to the dispersion as appropriate, and pH of the dispersion may be adjusted. The oxidation accelerator and residual monomers may be removed from the dispersion by purification means such as cation exchange and anion exchange.

The oxidation accelerator is an iron (III) salicylate complex. The iron (III) salicylate complex is a chelate complex in which salicylate ion is bonded to iron (III) ion, and hydroxy groups and carboxy groups of a ligand in ortho-position relative to iron (III) ion is coordinate-bonded to each other. By adding and the oxidation accelerator together with the monomers forming the conjugated polymer and performing chemical oxidative polymerization, the conductive polymer with the light absorption spectrum in which the index D is 4 or more can be produced.

The oxidation accelerator is produced by mixing an iron (III) compound and salicylic acid salt or borodisalicylic acid salt in the solvent. Salicylic acid is o-hydroxybenzoic acid in which a hydrogen atom in ortho-position relative to a carboxy group of the benzoic acid is replaced with a hydroxy group. This salicylic acid and iron (III) ions form a complex that is the oxidation accelerator. Note that m-hydroxybenzoic acid salt or p-hydroxybenzoic acid salt cannot form a complex that is the oxidation accelerator.

Furthermore, to produce the oxidation accelerator, salicylic acid salt or borodisalicylic acid salt is dissolved in water that is the solvent. The complex as the oxidation accelerator cannot be produced even when salicylic acid or borodisalicylic acid is added to the solvent instead of salt thereof. Salicylic acid salt or borodisalicylic acid salt may be added to the iron (III) compound according to the coordination number of iron (III) salicylate complex at stoichiometric ratio. Otherwise, since the iron (III) compound acts as the oxidation accelerator on its own, the iron (III) compound may be added excessively than the stoichiometric ratio.

The salicylic acid salt or borodisalicylic acid salt may be ammonium salt, quaternary ammonium salt, quaternary amidinium salt, amine salt, sodium salt, and potassium salt, etc. Quaternary ammonium ions of the quaternary ammonium salt may be tetramethylammonium, triethylmethylammonium, and tetraethylammonium, etc. The quaternary amidinium salt may be ethyldimethylimidazolinium and tetramethylimidazolinium, etc. The amine salt may be primary amines, secondary amines, and tertiary amines. The primary amine may be methylamine, ethylamine, propylamine, and the like, the secondary amine may be dimethylamine, diethylamine, ethylmethylamine dibutylamine, and the like, and the tertiary amine may be trimethylamine, triethylamine, tributylamine, ethyldimethylamine, and ethyldiisopropylamine, and the like.

The iron (III) compound may be inorganic acid iron such as iron (III) sulfate, iron (III) chloride, iron (III) perchlorate, iron (III) nitrate, iron (III) phosphate, iron (III) hexacyanide, etc. Organic acid iron may be iron carboxylates such as iron (III) citrate and iron (III) oxalate, and iron sulfonates such as iron (III) toluenesulfonate, iron (III) alkylbenzenesulfonate, iron(III) alkylnaphthalene sulfonate, and iron(III) anthraquinone sulfonate. Multiple iron (III) compounds may be mixed and used.

Note that other oxidation accelerator may be used together with the iron (III) salicylate complex. Other oxidation accelerator is preferably iron salt of organic acid and inorganic acid, and persulfates. For example, other oxidation accelerator may be iron (III) chloride hexahydrate, anhydrous iron (III) chloride, iron (III) nitrate nonahydrate, iron (III) nitrate, iron (III) sulfate n-hydrate, ammonium iron (III) sulfate dodecahydrate, iron (III) perchlorate n-hydrate, iron (III) tetrafluoroborate, copper (II) chloride, copper (II) sulfate, copper (II) tetrafluoroborate, nitrosonium tetrafluoroborate, ammonium persulfate, sodium persulfate, potassium persulfate, potassium periodate, hydrogen peroxide, ozone, potassium hexacyanoferrate (II), tetraammonium cerium (IV) sulfate dihydrate, bromine, iodine, iron dodecylbenzenesulfonate, iron (III) p-toluenesulfonate, iron (III) naphthalenesulate, iron (III) anthraquinonesulfonate, periodic acid, iodic acid, etc.

Although the concentration of the monomers forming the conjugated polymer are not especially limited in view of the ESR reduction in the high-frequency range, it is preferable that the monomers are added in the dispersion in the concentration of 1 mM to 6.25 mM. In this range, the conductive polymer is less likely to aggregate, and the particle size of the conductive polymer becomes 0.1 μm or less. Furthermore, in this range, the heat resistance increases, and the deterioration of various properties of the capacitor is suppressed even if the electrolyte capacitor is exposed under high-temperature environment.

The solvent of the dispersion may be any solvent if particles or powder of the conductive polymer are dispersed. For example, water, organic solvent, or mixtures thereof may be used as the solvent. Suitable organic solvent may be polar solvent, ketone, alcohol, ester, hydrocarbon, carbonate compound, ether compound, linear ether, heterocyclic compound, and nitrile compound, etc.

The polar solvent may be N-methyl-2-pyrrolidone, N,N-dimethylformamide, N,N-dimethylacetoamide, and dimethylsulfoxide. The ketone may be acetone. The alcohol may be methanol, ethanol, propanol, and butanol, etc. The ester may be ethyl acetate, propyl acetate, butyl acetate, and ethyl formate, etc. The hydrocarbon may be pentane, hexane, heptane, benzene, toluene, and xylene, etc. The carbonate compound may be ethylene carbonate and propylene carbonate, etc. The ether compound may be dioxane, diethylether, and tetrahydrofuran, etc. The linear ether may be ethylene glycol alkyl ether, propylene glycol alkyl ether, polyethylene glycol dialkyl ether, and polypropylene glycol alkyl ether, etc. The heterocyclic compound may be 3-methyl-2-oxazolidinone, etc. The nitrile compound may be acetonitrile, glutaronitrile, methoxyacetonitrile, propionitrile, and benzonitrile, etc.

Polyhydric alcohol may be contained in the dispersion as an additive. The polyhydric alcohol may be sorbitol, ethylene glycol, diethylene glycol, triethylene glycol, polyethylene glycol with molecular amount of about 200, polyoxyethylene glycol, glycerol, polyoxyethylene glycerin, xylitol, erythritol, mannitol, dipentaerythritol, pentaerythritol, or combination of two or more. Since the boiling point of the polyhydric alcohol is high, the polyhydric alcohol remains in the solid electrolyte layer even after the drying process, so that the conductivity is improved and ESR reduction and electrical resistance improvement effect can be obtained. Furthermore, other compounds may be included. For example, common additives such as organic binders, surfactant, defoamer, coupling agent, antioxidant, UV absorber, and the like may be added.

It is preferable to adjust the dispersion to be weakly acidic or neutral. Although a pH adjuster is not especially limited, the pH adjuster may be ammonia and sodium hydroxide, etc. If the pH is weakly acidic or neutral, the aggregation of the conductive polymer formed by the conjugated polymer which incorporated polystyrene sulfonic acid (PSS) as the dopant is unraveled, and the particle size of the conductive polymer becomes 0.1 μm or less. That is, hydrogen atoms having sulfo groups of PSS is hydrogen-bonded and causes the aggregation of the conductive polymer. However, when this hydrogen atom is replaced with sodium or ammonia and the like by neutralization reaction or when the environment becomes weakly acidic where hydrogen bonding less likely occurs, the hydrogen bonding does not occur, and the aggregation of the conductive polymer is suppressed. However, when the environment becomes alkali, dedoping reaction easily occur in the conjugated polymer, which is not preferred.

In the solid electrolytic capacitor in which the electrolytic solution is used together by impregnating in the electrolytic solution in the gap of the capacitor element, the electrolytic solution is solution formed by adding anion components and cation components to the solvent. Typically, the anion components and the cation components are organic acid salt, inorganic acid salt, or salt of composite compound of organic acid and inorganic acid, and are added to the solvent by ion dissociative salt which dissociates to the anion component and the cation component. Acid that is the anion component and base that is the cation component may be separately added to the solvent. Furthermore, the electrolytic solution may not include the anion component, the cation component, or both.

The solvent of the electrolytic solution is not especially limited, and a protic organic polar solvent or an aprotic organic polar solvent may be used. The protic organic polar solvent may be monohydric alcohol, polyhydric alcohol, and oxyalcohol compound, etc. The monohydric alcohols may be ethanol, propanol, butanol, pentanol, hexanol, cyclobutanol, cyclopentanol, cyclohexanol, benzyl alcohol, etc. The polyhydric alcohol and the oxyalcohol compound may be ethylene glycol, diethylene glycol, propylene glycol, glycerin, methyl cellosolve, ethyl cellosolve, methoxypropylene glycol, dimethoxypropanol, and alkylene oxide adduct of polyhydric alcohol such as polyethylene glycol and polyoxyethylene glycerin, etc.

The aprotic organic polar solvents may be sulfones, amides, lactones, cyclic amides, nitriles, and sulfoxides, etc. The sulfone may be dimethyl sulfone, ethylmethyl sulfone, diethyl sulfone, sulfolane, 3-methyl sulfolane, 2,4-dimethyl sulfolane, etc. The amide may be N-methylformamide, N,N-dimethylformamide, N-ethylformamide, N,N-diethylformamide, N-methylacetamide, N,N-dimethylacetamide, N-ethylacetamide, N,N-diethylacetamide and hexamethylphosphoricamide, etc. The lactone and the cyclic amide may be γ-butyrolactone, γ-valerolactone, δ-valerolactone, N-methyl-2-pyrrolidone, ethylene carbonate, propylene carbonate, butylene carbonate, and isobutylene carbonate, etc. The nitrile may be acetonitrile, 3-methoxypropionitrile, and glutaronitrile, etc. The sulfoxide may be dimethyl sulfoxide, etc.

The organic acid that become the anion component as a solute may be carboxylic acid such as oxalic acid, succinic acid, glutaric acid, pimelic acid, suberic acid, sebacic acid, phthalic acid, isophthalic acid, terephthalic acid, maleic acid, adipic acid, benzoic acid, toluyl acid, enanthic acids, malonic acids, 1,6-decandicarboxylic acid, 1,7-octanedicarboxylic acid, azelaic acid, resolcinic acid, fluorochloric acid, gallic acid, gentisic acid, protocatechuic acid, pyrocatechuic acid, trimellitic acid, and pyromellitic acid, phenols, and sulfonic acid, etc. The inorganic acid may be boric acid, phosphoric acid, phosphorus acid, hypophosphorous acid, carbonic acid, and silicic acid, etc. The composite compound of organic acid and inorganic acid may be borodisalicylic acid, borodioxalic acid, borodiglycolic acid, borodimalonic acid, borodichuccinic acid, borodiadipic acid, borodiazelaic acid, borodibenzoic acid, borodimarainic acid, borodilactic acid, borodiapple acid, borodi tartric acid, borodicitrate acid, borodiphthalic acid, borodi (2-hydroxy) isobutyric acid, borodiresorcinic acid, borodimethylsalicylic acid, borodinaftoeic acid, borodimandelic acid, and borodi (3-hydroxy) propionic acid, etc.

Furthermore, at least one salt of the organic acid, the inorganic acid, and the composite compound of organic acid and inorganic acid may be ammonium salt, quaternary ammonium salt, quaternary amidinium salt, amine salt, sodium salt, and potassium salt, and etc. Quaternary ammonium ions of the quaternary ammonium salt may be tetramethylammonium, triethylmethylammonium, and tetraethylammonium, etc. The quaternary amidinium salt may be ethyldimethylimidazolinium and tetramethylimidazolinium, etc. The amine salt may be primary amines, secondary amines, and tertiary amines. The primary amine may be methylamine, ethylamine, propylamine, and the like, the secondary amines may be dimethylamine, diethylamine, ethylmethylamine and dibutylamine, and the like, and the tertiary amines may be trimethylamine, triethylamine, tributylamine, ethyldimethylamine, ethyldiisopropylamine, and the like.

Furthermore, other additives may be added to the liquid. The additives may be complex compounds of boric acid and polysaccharides (mannit, sorbit, etc.), complex compounds of boric acid and polyhydric alcohol, borate esters, nitro compounds (o-nitrobenzoic acid, m-nitrobenzoic acid, p-nitrobenzoic acid, o-nitrophenol, m-nitrophenol, p-nitrophenol, p-nitrobenzylalcohol etc.), and phosphate esters, etc. These may be used in single or in combination of two or more.

Hereinafter, the conductive polymer dispersion and the electrolytic capacitor produced using the dispersion of the present disclosure will be described in more detail based on examples. Note that the present disclosure is not limited to the following examples.

### Dispersion

Dispersion of examples 1 to 2 and comparative examples 1 to 3 were produced as follows. Common matters in the production of the dispersion in all of the examples and the comparative examples were as follows. That is, a solvent of the conductive polymer dispersion was 500 ml of water. 2.5 mmol of EDOT (3,4-ethylene dioxythiophene), 5 mmol of polystyrene sulfonic acid (PSS), 3 mmol of ammonium persulfate (APS), 2 mmol of iron (III) sulfate [Fe₂(SO₄)₃], and additives shown in the below table 1 were added to the solvent.

TABLE 1

| | | Addition |
|---|---|---|
| | Additive | Amount/mmol |
| Example 1 | Ammonium Borodisalicylate | 1.5 |
| Example 2 | Ammonium Salicylate | 1.5 |
| Comparative Example 1 | None | 0 |
| Comparative Example 2 | Ammonium Phthalate | 5 |
| Comparative Example 3 | Ammnium Benzoate | 5 |

As shown in the table 1, in the example 1, 1.5 mmol of ammonium borodisalicylate was further added to the solvent. In the example 2, 1.5 mmol of ammonium salicylate was further added to the solvent. No additive was added in the comparative example 1. In the comparative example 2, 5 mmol of ammonium phthalate was further added to the solvent. In the comparative example 3, 5 mmol of ammonium benzoate was further added to the solvent.

Here, solution of the examples 1 and 2 showed reddish purple color when ferric sulfate and ammonium borodisalicylate or ammonium salicylate were mixed together. This change of color of the solution indicates that iron ions of ferric sulfate and salicylate ions of ammonium borodisalicylate or ammonium salicylate forms a complex, forming iron (III) salicylate complex The solution in the compartive examples 2 and 3 did not change their color, and it was found that iron ions of ferric sulfate and phthalate or benzoate did not form a complex.

The solution was left under temperature environment of 0 to 5° C. overnight with stirring. After leaving the solution overnight, the solution was ultrafiltrated and was dispersed by jet mixing. After the dispersion process, the solution was further ultrafiltrated, and the amount of the solvent was adjusted so that the concentration of the conductive polymer in the dispersion became about 2 wt %.

### Acquisition of Light Absorption Spectrum

The dispersion produced in the examples 1 and 2 and the comparative examples 1 to 3 was diluted by water so that the solid concentration in the dispersion became 0.04 wt %, and relationship between the wavelength of the irradiated light and the absorbance was measured by UV-vis. Note that light absorption spectrum of the water that is the dispersant was also measured by UV-vis as a blank.

### Measurement of Electrical Conductivity

Ethylene glycol was mixed to the dispersion so that the volume ratio of the dispersion (A) produced in the examples 1 and 2 and the comparative examples 1 to 3 and ethylene glycol (B) became A:B=70:30, and 100 μl of the mixture was dropped on a glass plate and was dried to form the conductive polymer on the glass plate. The electrical conductivity of film of the conductive polymer is measured by four-probe method. Note that the electrical conductivity of the same glass plate was also measured by four-probe method as a blank.

### Measurement Result

The below table 2 shows the absorbance at 585 nm, absorbance at 800 nm, and absorbance at 1200 nm in the light absorption spectrum acquired in the examples 1 and 2 and the comparative examples 1 to 3. Furthermore, an index D calculated from the absorbance is shown in the table 2. In addition, the electrical conductivity obtained by the four-probe method is shown in the table 2.

TABLE 2

| Absorbance A | Absorbance B | Absorbance A | Index D (D = | Electrical |
|---|---|---|---|---|
| at 585 nm | at 800 nm | at 1200 nm | (B + C)/A) | Conductivity/Scm⁻¹ |
| 1.47 | 2.38 | 4.11 | 4.41 | 1.2 × 10¹ |
| 1.30 | 2.00 | 3.50 | 4.23 | 6.1 × 10⁻¹ |
| 1.11 | 1.80 | 2.40 | 3.78 | 2.1 × 10⁻² |
| 1.13 | 1.68 | 1.93 | 3.19 | <1 × 10⁻⁷ |
| 1.10 | 1.59 | 3.23 | 3.46 | 8.5 × 10⁻⁵ |

As shown in the table 2, it was found that, in the conductive polymer included in the dispersion of the examples 1 and 2, the index D of the light absorption spectrum was 4 or more. In contrast, in the conductive polymer included in the dispersion of the comparative examples 1 to 3, the index D was less than 4. Furthermore, it was found that, the electrical conductivity of the examples 1 and 2 in which the index D was 4 or more was largely improved compared with those of the comparative examples 1 to 3, and the conductive polymer in which the index D of the spectrum is 4 or more showed high electrical conductivity.

Since the dispersion of the examples 1 and 2 showed reddish purple color, it was found that iron (III) salicylate was produced in the dispersion of the examples 1 and 2. In contrast, since the dispersion in the comparative examples 1 to 3 did not change their color, it was found that the dispersion in the comparative examples 1 to 3 did not include iron (III) salicylate and other complexes. From this fact, the result of the index D, and the electrical conductivity, it can be concluded that the electrical conductivity of the examples 1 and 2 in which the index D was 4 or more had largely improved compared with those of the comparative examples 1 to 3 because iron (III) salicylate acted as the oxidation accelerator.

1. A solid electrolyte capacitor comprising:
a capacitor element formed by an anode foil and a cathode foil facing each other; and
a conductive polymer adhered in the capacitor element,
wherein an index D derived by the following formula is 4 or more based on an absorbance A at 585 nm, an absorbance B at 800 nm, and an absorbance C at 1200 nm in a light absorption spectrum of the conductive polymer.
D=(B+C)/A

2. The solid electrolyte capacitor according to claim 1, wherein the conductive polymer is polyethylene dioxythiophene doped with polystyrene sulfonic acid.

3. (canceled)

4. The conductive polymer dispersion, wherein an index D derived by the following formula is 4 or more based on an absorbance A at 585 nm, an absorbance B at 800 nm, and an absorbance C at 1200 nm in a light absorption spectrum of a conductive polymer.
D=(B+C)/A

5. The conductive polymer dispersion according to claim 4, wherein the conductive polymer is polyethylene dioxythiophene doped with polystyrene sulfonic acid.

6.-9. (canceled)

10. A production method of conductive polymer dispersion, comprising performing chemical oxidative polymerization in solution including an iron (III) salicylate complex and monomers forming a conjugated polymer.

11. A production method of conductive polymer dispersion according to claim 10, comprising an oxidation accelerator production process of adding borodisalicylic acid salt or salicylic acid salt and an iron (III) compound to the solution and producing the iron (III) salicylate complex in the solution.
